(19) United States
(12) Patent Application Publication
(10) Pub. No.: US 2012/0280910 A1
(43) Pub. Date: Nov. 8, 2012

(54) CONTROL SYSTEM AND METHOD FOR CONTROLLING A PLURALITY OF COMPUTER DEVICES

(75) Inventor: Arjen Brinkman, Noordwijkerhout (NL)

(73) Assignee: ELMIRO BUSINESS DEVELOPMENT B.V., Noordwijkerhout (NL)

(21) Appl. No.: 13/510,865

(22) PCT Filed: Nov. 18, 2009
(86) PCT No.: PCT/NL2009/050694

§ 371 Date: Jun. 14, 2012

(51) Int. Cl. G06F 3/033

(52) U.S. Cl. 345/158

(57) ABSTRACT

The invention provides a control system for controlling a plurality of computer devices, the computer devices each having at least a processing unit, the control system comprising a pointer device, a tracking system connected to a processing unit of each of the plurality of computer devices, the tracking system comprising at least a tracking unit arranged to determine an actual position and/or orientation of the pointer device, wherein the tracking system is arranged to determine a parameter set representative of at least one of position and orientation of the pointer device and to select one of a plurality of computer devices depending on said parameter set and to send a control signal from the tracking system to a processing unit of the selected computer device wherein the control signal is based on said parameter set.

The invention relates to a control system for controlling a plurality of computer devices. Furthermore, the invention relates to a method for controlling a plurality of computer devices using a pointer device: The invention also relates to a control system for controlling a computer device.

Computer devices are becoming more and more commonplace in hospitals and laboratories, in particular in control rooms (CR) and operation rooms (OR). These devices typically have their own dedicated interaction equipment, such as a mouse and a keyboard.

An operator of these devices, for example a controller or a surgeon, generally cannot control these systems from any location in the hospital room. When a plurality of computer devices are used simultaneously, for example during a surgery, the operator must control the plurality of computer devices by interacting, in turn, with each computer device's own control interface, which is not convenient.

Furthermore, as it is essential for a surgeon to work only with sterile equipment in an OR, standard mice and keyboards cannot be used by the operating surgeon. In practice, an assistant is often responsible for controlling the computer devices, acting on verbal instructions from the surgeon. This is not an efficient arrangement and potentially dangerous due to the possibility of communication errors.

A general drawback of input devices used by persons is that they tend to become dirty due to physical contact with persons. Due to the delicate nature of some input devices, cleaning and/or sterilizing those devices can be a tedious or impossible work, making their use in a environment where sterile conditions are essential difficult or impossible.

Under some conditions, more than one person needs to send control signals to control computer device. For example, in a case where one person is manipulating computer data in a program, examining the data on his or her personal screen, while another person, a speaker, is explaining aspects of the computer data to a group of people, wherein the computer data representation is shown on a large screen, and the representation is controlled by the speaker and/or by the person manipulating the computer data.

It is an object of the invention to provide a control system that allows a more convenient way to control computer devices. It is a further object of the invention to provide a control system that overcomes at least one of the aforementioned drawbacks.

At least an object is met by providing a control system for controlling a plurality of computer devices, the computer devices each having at least a processing unit, the control system comprising:
at least a pointer device,
a tracking system connected to a processing unit of each of the plurality of computer devices, the tracking system comprising at least a tracking unit arranged to determine an actual position and/or orientation of the pointer device,
wherein the tracking system is arranged
to determine a parameter set representative of at least one of position and orientation of the pointer device and
to select one of a plurality of computer devices depending on said parameter set and
to send a control signal from the tracking system to a processing unit of the selected computer device wherein the control signal is based on said parameter set.

Advantageously, the plurality of computer devices can be controlled using a single pointer device. The tracking unit or units can be advantageously arranged to determine the position and/or orientation of (hereafter also indicated as “to track”) the pointer device wherein the pointer device can be located (almost) anywhere in the room containing the computer devices and the tracking system. That way, a great degree of freedom is offered to the operator of the computer devices. The tracking system is arranged to determine a parameter set representative of at least one of position and orientation of the pointer device, and to select the target computer device based on that. Advantageously, this allows the operator to, for example, simply point the pointer device at the relevant computer device to start controlling it. The control signals generated by the tracking system and sent to the selected or targeted computer device are based on the parameter set. This advantageously allows the user of the pointer device to make intuitive movements to control the computer. For example, moving or pointing the pointing device up may move a cursor on the computer device's screen up. The tracking system is arranged to send the control signal so that it can be processed by a processing unit of the computer device. This processing can include moving a cursor or pointer on screen, selecting an option in a user interface, manipulating 2- or 3-dimensional data, or representations thereof, etc. A part of the tracking system may be implemented as a software driver, wherein an instance of the software driver runs on one or more of the plurality of computer devices. The computer devices may be interconnected using a data network or general data connection. In case the tracking system comprises multiple tracking units, said multiple tracking units may be interconnected using a data network or data connection, for example to exchange measured data relating to position and/or orientation of the pointer device.

In an embodiment according the invention, the tracking system comprises a plurality of tracking units, each tracking unit being arranged to determine an actual position and/or orientation of the pointer device. Using multiple tracking units, it is advantageously possible to cover a wider area, so that the operator using the pointer device is provided with more freedom to move around.

In an embodiment according the invention, the tracking unit is an optical tracking unit, preferably a camera unit. The camera unit may be arranged to detect visible light, infrared light, and/or radiation from some other part of the electromagnetic spectrum. An advantage of infrared light is that it is invisible and, in low dosages intended for tracking objects, harmless for the user. The tracking unit may be provided with an infrared light source, and the pointer device may be arranged to reflect the infrared light, thus becoming clearly visible to the infrared camera. Alternatively, the camera unit may register a sequence of visible light images, and be provided with computer vision means to determine from the images the position, orientation, or any other relevant state of the pointer device. The camera may be arranged to detect a color of the pointer device, an internal arrangement (such as relative position of legs or other parts of the pointer device), or the color of a light on the pointer device.

In an embodiment according the invention, the pointer device is provided with markers, and the tracking unit is arranged to detect said markers. Said markers may be infrared light reflecting, allowing an infrared camera to track them. The markers may be distributed in a known 2- or 3-dimensional pattern, so that from the measured pattern the relative distance (position) and orientation of the pointer device may be determined.

In an embodiment according the invention, the pointer device comprises a wearable glove. For example in a surgery, the surgeon's glove may be used as a pointer device. This advantageously removes the need for the surgeon to pick up a separate pointer device in order to control a computer device.

In an embodiment according the invention, the pointer device is a disposable object intended for short term use. Advantageously, by making the pointer device disposable, the problem to keep it sterilized over a longer period of time is removed. For example, the pointer devices may be supplied as sterilized objects in a shrink-wrapped package which is opened in the OR before or during the surgery. After use, the pointer devices are discarded. Pointer devices that are tracked by a tracking unit comprising a camera unit or some other active contactless tracking means, need not contain expensive technology, hence they can be advantageously made as low cost disposable objects.

In an embodiment according the invention, the pointer device is a made of biodegradable material. If the pointer devices are intended as disposable objects for short term use, it is advantageous to make the devices (possibly including markers on the devices) of biodegradable material, so that disposing of the objects has a reduced environmental impact.

In an embodiment according the invention, the pointer device is the user's hand, and the tracking unit is arranged to detect hand gestures. Especially when a visible light camera combined with computer vision means is part of the tracking unit, the pointer device may be the operator's hand. By simply moving the hand, or by making gestures, input signals can be sent to a computer device. A gesture may be to point a finger at the computer device to be targeted. Advantageously, this allows for an intuitive way of interacting with the computer devices.

In an embodiment according the invention, the control system is arranged to provide a signal to the user indicating which computer device is selected. The signal can for example be an audio or vision signal, as feedback to the user which computer device is currently selected. It can for example be implemented as a lit light on the tracking unit closest to the selected computer device, or as a visual indicator on the computer screen of the selected computer device. This advantageously can prevent confusion of the user, and accidental interaction with a computer device that the user did not intend to select.

In an embodiment according the invention, the control system comprises a plurality of pointer devices, wherein the control system is arranged so that each of the plurality of pointer devices can selectively control each of the computer devices. Thus, advantageously multiple persons working in the same room can control each of the computer devices in that room, each person using his or her own pointer device.

The invention further provides a method for controlling a plurality of computer devices using a pointer device, the method comprising:
determining a parameter set representative of at least one of position and orientation of the pointer device,
selecting one of a plurality of computer devices depending on said parameter set,
sending a control signal from the tracking system to the selected computer device wherein the control signal is based on said parameter set.

The method advantageously allows an operator to control a plurality of computer devices using a single input device.

In an embodiment, the method additionally comprises providing a signal to the user indicating which computer device is currently selected. This advantageously can prevent confusion and accidental interaction with a computer device that the user did not intend to select.

The invention provides a control system for controlling a computer device, the computer device having at least a processing unit, the control system comprising:
a disposable pointer device intended for short term use,
a tracking system connected to a processing unit of the computer device, the tracking system comprising at least a tracking unit arranged to determine an actual position and/or orientation of the pointer device,
wherein the tracking system is arranged
to determine a parameter set representative of at least one of position and orientation of the pointer
to send a control signal from the tracking system to a processing unit of the computer device wherein the control signal is based on said parameter set.

As was mentioned before, by using a disposable pointer device, the need to clean and/or sterilize the pointer device after using it, is removed. Since the control system comprises a tracking system that is preferably never in direct physical contact with the operator or user of the computer device, the tracking system does not need to be cleaned or sterilized as thoroughly as a device that comes in contact with, for example, a surgeon's bloodied glove. The more expensive components of the control system are advantageously located in the tracking system, making it possible to create a low-complexity and low cost and thus disposable pointer device.

In an embodiment according the invention, the disposable pointer device is made of biodegradable material.

In an embodiment according the invention, the tracking system comprises a plurality of tracking units, each tracking unit being arranged to determine an actual position and/or orientation of the pointer device.

In an embodiment according the invention, the disposable pointer device comprises a wearable glove.

The invention further provides a control system for controlling a computer device, the computer device having at least a processing unit and a plurality of display screens, the control system comprising:
at least a pointer device,
a tracking system connected to a processing unit of the computer devices, the tracking system comprising at least a tracking unit arranged to determine actual positions and/or orientations of each pointer device,
wherein the tracking system is arranged
to determine a parameter set representative of at least one of position and orientation of the at least one pointer device and
to send a control signal from the tracking system to a processing unit of the selected computer device wherein the control signal is based on said parameter set,
wherein the computer device is arranged to update at least one of the plurality of connected screens based on the control signal.

The control system for controlling a computer device with multiple screens using multiple input devices advantageously lets multiple people send input signals to the same computer device. As such they can work together, for example, one person can manipulate the orientation of a 3D model viewer, while another can zoom in on specific aspects. One of the computer displays attached to the computer device may be a screen intended for use by one person, while another display may be a larger screen intended for a group of persons.

### BRIEF DESCRIPTION OF THE FIGURES

FIGS. 1a, 1b, and 1c schematically show a user interacting with a plurality of computer devices according to an embodiment of the invention.

FIG. 2 schematically shows a user interacting with a plurality of computer devices according to a further embodiment of the invention.

FIG. 3 schematically shows a pointer device comprising a wearable glove.

FIG. 4 schematically shows a further pointer device.

FIG. 5 schematically shows a further pointer device.

FIG. 6 shows a flow diagram of a method according the invention.

### DETAILED DESCRIPTION

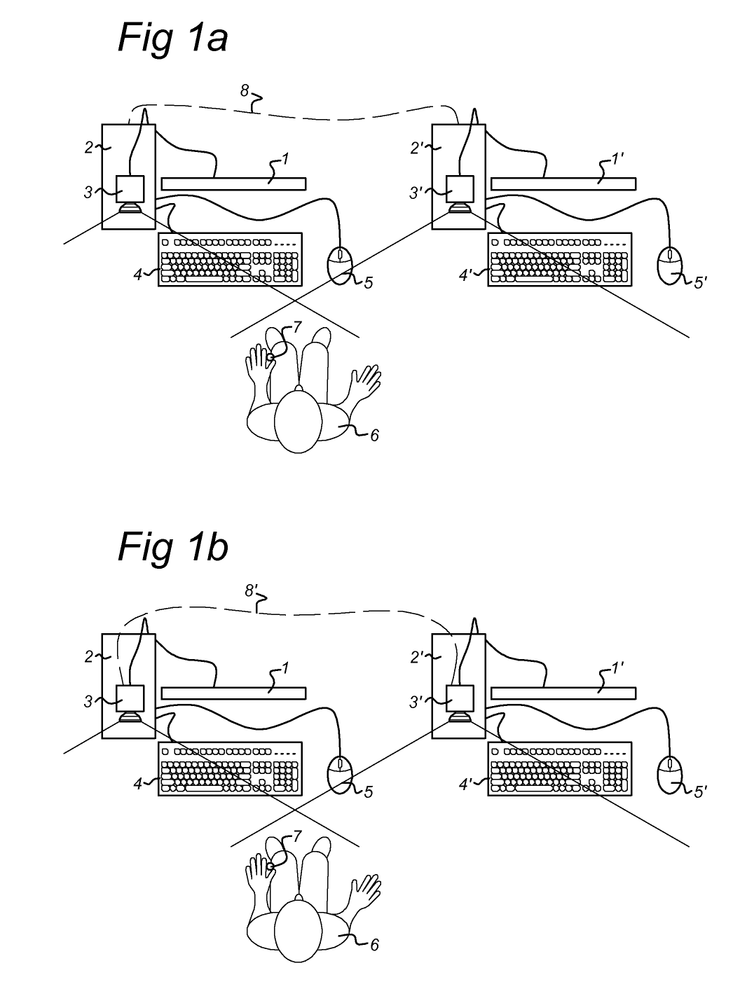

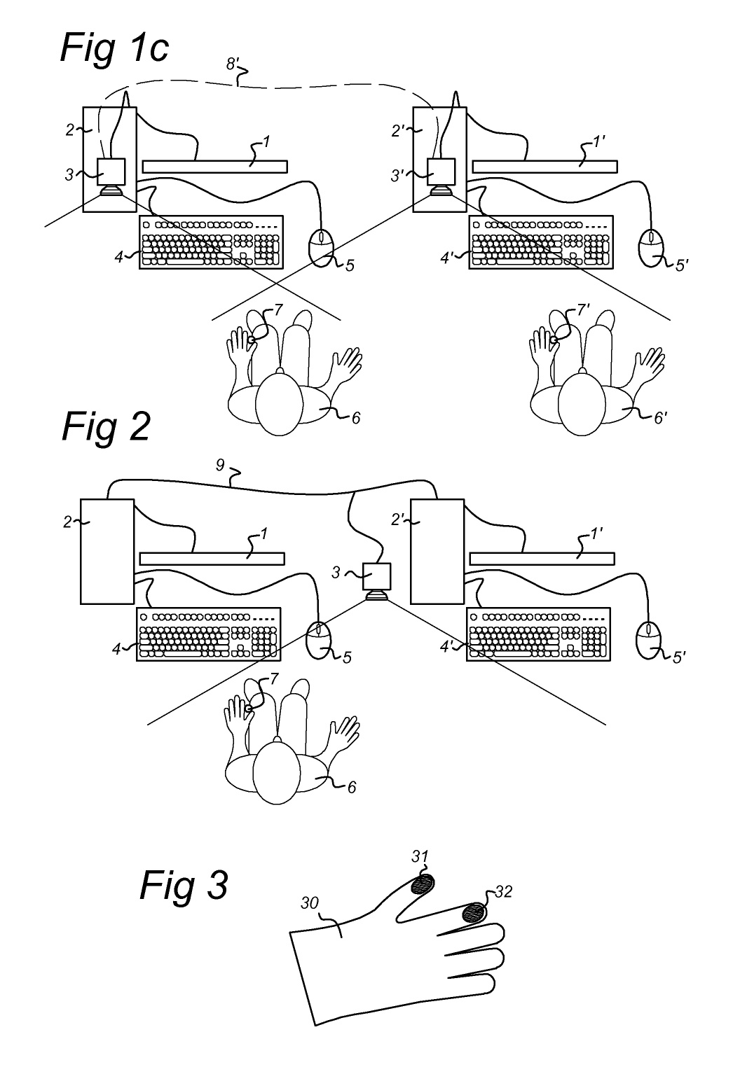

FIG. 1a schematically shows a user 6 interacting with two computer devices 2, 2′ according to an embodiment of the invention. Each computer device 2, 2′, which may be for example a personal computer or a workstation, is connected to a display screen 1, 1′, keyboard 4, 4′, and mouse 5, 5′. The user 6 is holding a pointer device 7, in this case a pointer object 7. More details about pointer devices will be given in reference to FIGS. 3-5. The computer devices have at least a processing unit (not shown). In an example, a processing unit of a computer device 2 is located in a different room than the user 6 and the display 1 of the computer device 2.

Two tracking units 3, 3′ for determining the actual position and/or orientation of the pointer device with respect to a coordinate system are provided. In one embodiment, tracking unit 3 is connected to computer device 2, and tracking unit 3′ is connected to computer device 2′. Computer devices 2 and 2′ are interconnected by data connection 8, which may be realized by a dedicated cable, a network connection, a wireless network connection, or any other digital connection between the two devices.

The computer devices 2, 2′ are arranged to run driver software so as to cause the device to read data representative of the position and/or orientation of the pointing device from the connected tracking units 3, 3′, and to exchange said data over the data connection 8. In this embodiment, the tracking units 3, 3′ and the computer driver software on the computer devices 2, 2′ form a tracking system. The tracking system together with the pointer device 7 forms a control system for controlling a plurality of computer devices.

The user 6 works with the systems as follows. In order to control a computer device, for example by moving a cursor on the screen, selecting an option, entering a command, or manipulating a 2-dimensional or 3-dimensional data representation, the user 6 moves the pointer device 7. Tracking units 3, 3′, which may comprise visible light or infrared camera's, are arranged to detect the pointer device 7, in particular certain markers on the surface of the pointer device 7. In an exemplary embodiment, the tracking unit 3 comprises an infrared camera detecting light reflected from the markers of the pointing device and an infrared source radiating towards the user, and the markers reflect infrared light from the source. In a further exemplary embodiment, the tracking unit 3 comprises a digital visible light camera and logic circuits to determine the presence of one or more markers in the images recorded by the camera. As such, the tracking unit 3, 3′ determines at least one of an actual position and orientation of the pointing device. In order to determine a position, in principle one marker on the pointing device suffices. In order to determine an orientation it is generally convenient to work with multiple markers. An alternative is a computer vision approach, wherein the position and orientation of the pointer devices is determined using an analysis of camera images, which does not necessarily require markers.

Each tracking unit 3, 3′ sends data representative of the position and/or orientation to the respective connected computer devices 2, 2′. The computer device 2 runs driver software (hereafter also “driver software instances”) which receives said data from the connected tracking unit 3. It further receives data from the tracking unit 3′ which is transmitted by the similar driver software on the computer device 2′ over the data connection 8. Vice versa, the software driver of computer device 2 sends the received data from tracking unit 3 to the software driver of computer device 2′ via the data connection 8. As such, the driver software on both computer devices 2, 2′ is provided with the data representative of the position and/or orientation of the pointer device 7 as detected by each tracking unit 3, 3′.

The driver software is arranged to determine from this data a parameter set representative of at least one of position and orientation of the pointer device. It may for example combine the relative (to a coordinate system of the tracking unit) position and orientation measurements of the various tracking units into a single position and orientation measurement in a predetermined coordinate system. Furthermore, the driver software is arranged to determine which of the computer devices 2, 2′ the user 6 intends to control, by analyzing the position or orientation of the pointer device. In an exemplary embodiment, the driver software will apply predetermined knowledge of the positions and orientations of the tracking units 3, 3′with respect to the computer devices 2, 2′or the screens 1, 1′, and determine from the received data and this knowledge towards which computer device 2, 2′ or screen 1, 1′ the pointer device 7 is oriented, thus determining which computer device 2, 2′ the user 6 intends to control. The predetermined knowledge of the positions and orientations of the tracking units 3, 3′and the computer devices 2, 2′ may be obtained and set in a calibration procedure that is executed at least once before use of the control system. In another exemplary embodiment, the driver software determines which computer device 2, 2′or screen 1, 1′ is closest to the pointer device 7, thus selecting one of the computer devices 2, 2′ (hereafter also called the targeted computer device).

Each driver software instance running on the computer devices 2, 2′ will receive the same data, and hence comes to the same selection of the targeted computer device. The driver software instances of the computer devices which are not targeted will now stop processing the data. The driver software on the targeted computer device will now send a control signal which is based on the parameter set to a processing unit of the computer device. For example, the driver software may send a detected relative change in position of the pointer device as cursor movement for further processing by the computer device. As such, the driver software functions similar to the way for example a mouse driver of a computer system functions.

In an alternative embodiment, only one instance of driver software will analyze the position/orientation data from the tracking units and determine a selected computer. This driver software, which can be said to be operating in “master” mode, will then communicate the results to the relevant other driver software instances, which can be said to be functioning in “slave” mode. Other similar arrangements may be available to a skilled person.

In an embodiment, the tracking units detect more than position and/or orientation. For example, they may register the state of a button or the color of a light on the pointing device 7. The parameter set determined by the tracking system can then also comprise this state or color. For example, a transition of state of a button may be interpreted as a “mouse click” event for the selected computer device.

The keyboards 4, 4′ and mice 5, 5′ can be used to control the computer device in the standard manner. However, in an example they may be absent and the device may be completely controlled as outlined in the preceding text.

The tracking units 3, 3′ may have a light or any other indicator, to signal which computer device 2, 2′ is being controlled. For example, if the tracking system determines that computer device 2 is being controlled, a light on tracking unit 3, which is closest to computer device 2, may be turned on. Alternatively, a visual indication on the screen 1 of computer device 2 may be shown. In a further alternative, an audible signal is used.

FIG. 1b shows a setup that is very similar to the one of FIG. 1a. However, in this case data connection 8 is removed or at least used for another purpose, and data connection 8′ links tracking units 3 and 3′ directly. The computer devices 2, 2′ no longer need to run driver software for the tracking units. In this example, driver units 3, 3′ and data connection 8′ form the tracking system, and driver units 3, 3′, data connection 8′ and pointer device 7 form the control system.

The functioning of the control system is very similar to the function of the control system as described in reference to FIG. 1a. The role of the software driver instances running on computer devices 2, 2′ of figure la is now taken over by hardware or software of the tracking units 3, 3′.

Each tracking unit 3, 3′ collects data related to at least one of position and orientation of the pointer device 7. This data is exchanged via data connection 8′ (which may be for example a cable, a network, or a wireless connection). The software or hardware of at least one of the tracking units 3, 3′ determine a parameter set representative of at least one of position and orientation of the pointer device. Based on this set, a targeted computer device is selected, and a control signal is sent to this computer device, in this example via the connected tracking unit of the computer device.

It is an advantageous aspect of this particular example that no additional driver software for the tracking units 3, 3′ needs to be installed on the computer devices 2, 2′. The connection to the computer devices may be in the form of a standard mouse or keyboard connection, using for example a dedicated mouse or keyboard cable and connector, or a general purpose USB connection.

FIG. 1c is similar to FIG. 1b, with the difference that FIG. 1c shows an additional user 6′ holding additional pointer device 7′. The control system in this figure thus comprises a plurality of pointer devices 7, 7′. As before, the user 6 can selectively control one of the computer devices 2, 2′. The tracking system will determine which computer device the user 6 intends to control based on the mentioned parameter set. The tracking system can support multiple pointer devices 7, 7′. The additional user 6′ can therefore also selectively control one of the computer devices 2, 2′ in a similar manner. In this case, the parameter set of the tracking system may comprise two position and/or orientation values, one for each of the pointer devices. The computer devices 2, 2′, the display devices 1, 1′, the tracking units 3, 3′, or any other suitable device near the controlled computer devices or display device may be arranged to signal to the users 6, 6′ which device is currently being controlled, and by whom. For example, a light may be used, where a green light can indicate a selection of the computer device by user 6 and a red light a selection by user 6′. This can be combined with an aspect of the the pointer devices, for example the pointer device 7 may be green and pointer device 7′ may be red.

In case two or more users intend (or seem to intend) to use the same computer device, the control system is arranged to resolve the situation. This may happen according to a number of rules, for example: the user who first gains control of the device, keeps it, so the other users cannot control the computer device until the first user is done. Alternatively, the control signals of all users may be averaged. In a further example, the application running on the computer device may be arranged to accept multiple control signals, for example with one control signal controlling aspects of a 3D data set, and another control signal controlling a visual representation mode of the 3D data set.

The number of pointer devices 7, 7′ is not linked to the number of tracking units 3, 3′nor to the number of computer devices 2, 2′ or screens 1, 1′. There may be more or less pointer devices 7, 7′ than tracking units 3, 3′, or the number of pointer devices may be equal to the number of tracking units. Similarly, there may be more or less pointer devices 7, 7′ than computer devices 2, 2′, or their numbers may be equal. Also, there may be more pointer devices 7, 7′ than users 6, 6′ using the control system.

FIG. 2 schematically shows a user 6 using a pointer device 7 interacting with a plurality of computer devices 2, 2′ according to a further embodiment of the invention. In this exemplary embodiment, the tracking system comprises a single tracking unit 3. The tracking unit is connected to computer devices 2, 2′ via data connection 9, which is preferably a wireless network. Alternatively, data connection 9 can be a wired network or a collection of data cables, such as USB cables or specific mouse and/or keyboard cables. Other ways of connecting tracking unit 3 to a plurality of computer devices 2, 2′ will be available to a skilled person.

The tracking unit 3 is arranged to determine at least one of an actual position and orientation of the pointer device 7. The tracking unit is further arranged to determine a parameter set representative of a position and/or orientation of the pointer device. Based on the data set, the targeted computer device will be selected. Finally, the tracking unit will send control data based on the parameter set to the computer devices. The examples and additions discussed in reference to the examples of FIG. 1a and FIG. 1b, also apply to this example.

An advantageous aspect of this example is that the use of a single tracking unit means that the communication of data between tracking units 3, 3′, as discussed in reference to FIGS. 1a and 1b, is not longer needed.

An example of the use of a plurality of computer devices in an arrangement as discussed in reference to FIGS. 1a, 1b, 1c, or 2, is the following. The computer device 2′ with peripherals 1′, 4′, 5′ may be arranged as workstation intended for a single user. The computer device 2 may have a large screen 1 intended for showing an image to a group of people, for example an audience listening to a lecture. The computer device 2 peripherals 4 and 5 may be omitted. The lecturer or an assistant can set up the application he or she intends to use during the lecture using the computer device 2′ and any combination of input devices 4′, 5′ and pointer device 7. Then, when addressing the audience the user 6 may walk over with the pointer device towards the large screen 1, thus targeting computer device 2 in the process. The computer device 2 will copy the state of the pre-set application on computer device 2′ and the lecturer can continue using the pointer device 7 to manipulate the application now running on computer device 2, while addressing the audience.

The plurality of users 6, 6′ and particularly pointer devices 7, 7′ shown and discussed in reference to FIG. 1c, can also be present in the control systems shown and discussed in reference to FIGS. 1a, 1b, 2, and 7. As was mentioned, there is no fixed link between the number of pointer devices 7, 7′ and the number of tracking units 3, 3′, display units 1, 1′, and/or computer devices 2, 2′.

FIGS. 3, 4, and 5 schematically show a number of pointer devices 7.

FIG. 3 schematically shows a pointer device comprising a wearable glove 30 having markers 31 and 32. As was mentioned before, these markers may be infrared reflecting markers. As an alternative, these markers may have a distinct color that is detected by a visible light camera. As a further alternative, the glove has no markers and the tracking unit attempts to determine the position and orientation of the pointer device from registered camera images of the glove.

The glove may be a surgical glove, intended for use in sterile conditions. The glove may be a disposable glove, intended for short term use only. For example, the glove and/or the markers may be made of biodegradable material.

Bringing the two markers 31 and 32 together may be interpreted by the tracking system as a selection, or “mouse click”, event and sent to the targeted computer as such. The tracking system may be arranged to recognize the user wearing the glove pointing in a certain direction with the gloved hand, and determine from the orientation of the glove the computer device that the user is pointing to, thus targeting the computer device. The tracking system may be arranged to detect a gesture of the gloved hand, for example a waving gesture, pushing gesture, etc, and link certain control signals to it, such as closing windows, pushing buttons, etc.

All the examples mentioned in reference to the glove, also apply to a user not wearing a glove, but showing his or her hand to the tracking unit. The hand may be equipped with a worn marker (such as on a ring or bracelet) or free of markers, depending on the arrangement of the tracking unit.

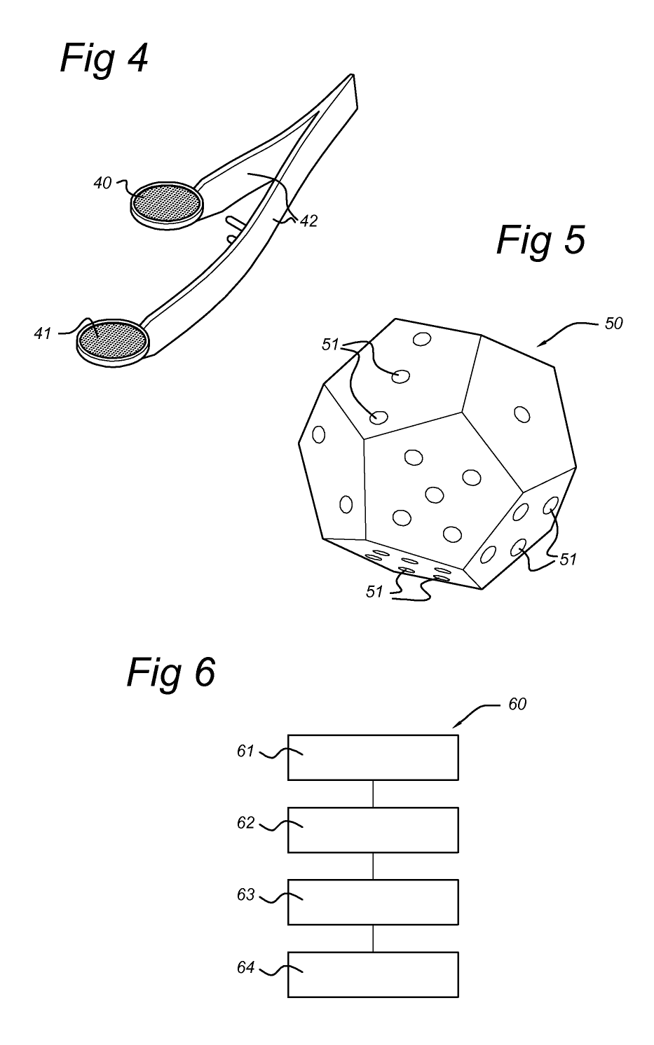

FIG. 4 schematically shows a further pointer device. The device has two legs 42, each leg having a marker 40, 41. The legs can be brought together to connect with each other, which may be interpreted by the tracking system as a selection or “mouse click” event. The two markers are distanced with respect to each other, making it possible to deduce an orientation of the device from a detected position of each marker.

FIG. 5 schematically shows a pointer device in the form of a dodecahedron 50, where each hexagonal surface element is provided with markers in a particular arrangement. By detecting the arrangement of the markers visible to the tracking unit, the tracking unit can determine which side of the dodecahedron 50 it is facing, and thus what orientation the pointing device has relative to the tracking unit.

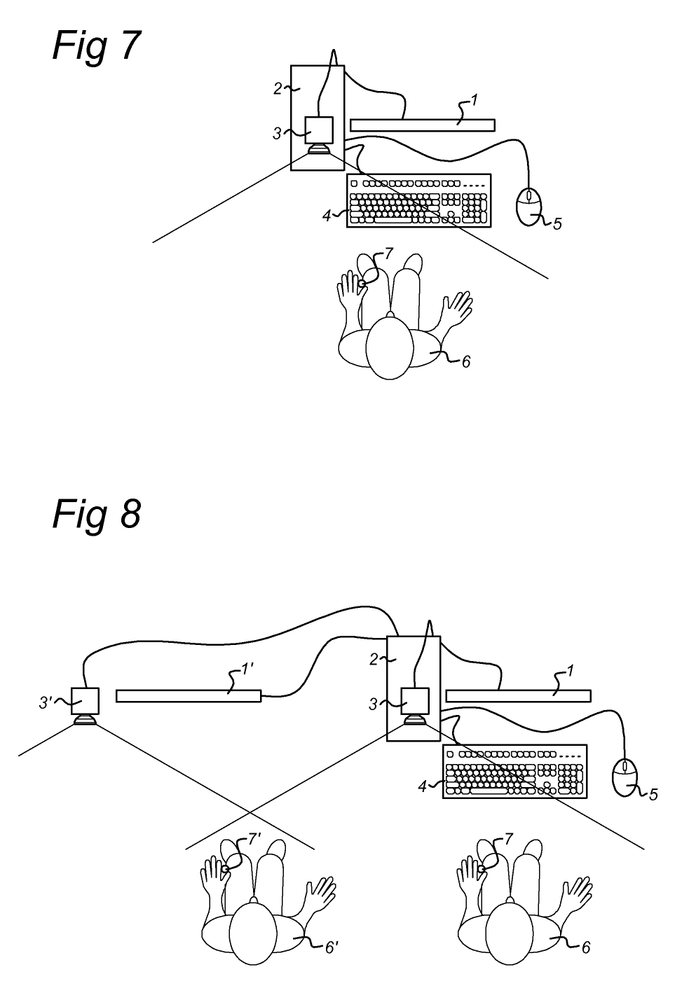

FIG. 6 shows a flow diagram of a method according the invention. The method is for controlling one of a plurality of computer devices using a pointing device.

As a first step, 61, a parameter set representative of at least one of position and orientation of the pointer device is determined. The parameter set thus determined may be compared with a previously determined parameters set. For example, comparing two positions determined at different points in time will yield a rate of change of position or velocity of the pointer device.

In a second step 62, one of a plurality of computer devices is selected as targeted computer device based on said parameter set. For example, the computer device positioned closest to the determined pointer device position may be determined, or the computer device that is positioned closest to a line extending from the pointer device in a preferred direction depending on the orientation of the pointer device.

In a third step 63, a control signal is sent from the tracking system to the computer device or to a processing unit of the computer device. The control signal may be a movement, for example to move a mouse pointer on a screen of the computer device. The control signal may also comprise a mouse click event.

A fourth, optional, step 64 is to send a signal indicating which computer device is selected to the user. This signal can be an audio or video signal emitted by the selected computer device or the tracking unit closest to it. The signal may be in the form of a lit light on the closest tracking unit.

FIG. 7 schematically shows a control system for controlling a computer device 2. The user 6 works with the control system in a similar manner as discussed in reference to FIGS. 1a, 1b, and 2. In this example, there is a single computer device to be controlled, so the tracking system is not arranged to select a computer device from a plurality of computer devices. The pointer device 7 is a disposable pointer device, preferably made of biodegradable material.

FIG. 8 schematically shows a computer device 2 with a plurality of monitors 1, 1′ attached to it. Two users 6, 6′ each have a pointer device, 7 and 7′ respectively. The tracking unit 3 is arranged to detect a position and/or orientation of the pointer device 7, and the tracking unit 3′ is arranged to detect a position and/or orientation of the pointer device 7′. For example, tracking unit 3 may comprise a visible camera looking for a blue marker with pointer device 7 having a blue marker, whereas tracking unit 3′ looks for a green marker on pointer device 7′. In one example the computer device 2 is arranged to generate two views generated by an application of the computer device 2, for example two representations of a 2D or 3D dataset, showing one view on display 1 and the other view on display 1′. Display 1′ may be a larger display intended for displaying to a group of people, and display 1 may be a display as part of a personal computer or workstation, intended for a single user. The control signals generated in response to the actions of the user 6′ with the pointer device 7′ will influence the representation of data on display 1′, and the actions of user 6 with pointer device 7 will influence the representation of data on display 1. As such, the person 6 working with pointer device 7, and possibly input devices 4 and 5, can prepare and interact with a software application, setting the application up for the second user 6′, who may give a presentation to a group of people, while using his input device 7′ to manipulate the view shown on the display 1′.

In another example, both tracking units 3, 3′ are arranged to each detect a position and/or orientation of both pointer devices 7, 7′. In a variation of this example, tracking unit 3′is absent. In this case, the tracking system comprising at least tracking unit 3 will determine two positions and/or orientations, one for each pointer device 7, 7′, and from that synthesize a single position and/or orientation. For example, the tracking system may use the position and/or orientation corresponding to the pointer device 7 or 7′ which has been the most active recently. In that way, both users 6 and 6′ can control the computer system 2, provided they do not attempt to do so simultaneously. For cases in which simultaneous control is required, other solutions exist such as averaging or otherwise filtering both determined orientations and/or positions.

While embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

1-19. (canceled)

20. A control system for controlling a plurality of computer devices, the computer devices each having at least a processing unit, the control system comprising:
at least a pointer device;
a tracking system connected to a processing unit of each of the plurality of computer devices, the tracking system comprising at least a tracking unit arranged to determine an actual position and/or orientation of the pointer device;
wherein the tracking system is arranged to determine a parameter set representative of at least one of position and orientation of the pointer device based on a detection by the tracking system of markers provided on the pointer device or on a recognition by the tracking system of camera images of the pointer device; and
to select one of a plurality of computer devices depending on said parameter set; and
to send a control signal from the tracking system to a processing unit of the selected computer device wherein the control signal is based on said parameter set.

21. The control system according to claim 20, wherein the tracking system comprises a plurality of tracking units, each tracking unit being arranged to determine an actual position and/or orientation of the pointer device.

22. The control system according to claim 20, wherein the tracking unit is an optical tracking unit, preferably a camera unit.

23. The control system according to claim 20, wherein the pointer device is provided with markers, and wherein the tracking unit is arranged to detect said markers.

24. The control system according to claim 20, wherein the pointer device comprises a wearable glove.

25. The control system according to claim 20, wherein the pointer device is a disposable object intended for short term use.

26. The control system according to claim 20, wherein the pointer device is a made of biodegradable material.

27. The control system according to claim 20, wherein the pointer device is the user's hand, and wherein the tracking unit is arranged to detect hand gestures

28. The control system according to claim 20, wherein the control system is arranged to provide a signal to the user indicating which computer device is selected.

29. The control system according to claim 20, wherein the control system comprises a plurality of pointer devices, wherein control system is arranged so that each of the plurality of pointer devices can selectively control each of the computer devices.

30. A method for controlling a plurality of computer devices using a pointer device, the method comprising:
determining a parameter set representative of at least one of position and orientation of the pointer device based on a detection by a tracking system of markers provided on the pointer device or on a recognition by the tracking system of camera images of the pointer device;
selecting one of a plurality of computer devices depending on said parameter set; and
sending a control signal from the tracking system to the selected computer device wherein the control signal is based on said parameter set.

31. A method according to claim 30, the method additionally comprising:
providing a signal to the user indicating which computer device is currently selected.

32. A control system for controlling a computer device, the computer device having at least a processing unit, the control system comprising:
a disposable pointer device intended for short term use;
a tracking system connected to a processing unit of the computer device, the tracking system comprising at least a tracking unit arranged to determine an actual position and/or orientation of the pointer device; and
wherein the tracking system is arranged to determine a parameter set representative of at least one of position and orientation of the pointer based on a detection by the tracking system of markers provided on the pointer device or on a recognition by the tracking system of camera images of the pointer device; and
to send a control signal from the tracking system to a processing unit of the computer device wherein the control signal is based on said parameter set.

33. The control system according to claim 32, wherein the disposable pointer device is made of biodegradable material.

34. The control system according to claim 32, wherein the tracking system comprises a plurality of tracking units, each tracking unit being arranged to determine an actual position and/or orientation of the pointer device.

35. The control system according to claim 32, wherein the disposable pointer device comprises a wearable glove.

36. A control system for controlling a computer device, the computer device having at least a processing unit and a plurality of display screens, the control system comprising:
at least a pointer device;
a tracking system connected to a processing unit of the computer device, the tracking system comprising at least a tracking unit arranged to determine actual positions and/or orientations of each pointer device;
wherein the tracking system is arranged to determine a parameter set representative of at least one of position and orientation of the at least one pointer device based on a detection by the tracking system of markers provided on the pointer device or on a recognition by the tracking system of camera images of the pointer device; and
to send a control signal from the tracking system to a processing unit of the selected computer device wherein the control signal is based on said parameter set; and
wherein the computer device is arranged to update at least one of the plurality of connected screens based on the control signal.
